(19) United States
(12) Patent Application Publication
(10) Pub. No.: US 2026/0242618 A1
(43) Pub. Date: Aug. 20, 2026

(54) POLYMER FOAM COMPRISING PHTHALONITRILE-BASED RESINS AND CARBOXYLATE-CONTAINING BLOWING AGENTS AND METHODS OF PREPARING SAME

(71) Applicant: Cambium Biomaterials, Inc., El Segundo, CA (US)

(72) Inventors: Matthew Wade Palmer, Tehachapi, CA (US); Egle Puodziukynaite, Ridgecrest, CA (US); John Allen Daguerre-Bradford, Lancaster, CA (US); Andrea Effron Mael, Tehachapi, CA (US); Benjamin Grant Harvey, Ridgecrest, CA (US)

(21) Appl. No.: 19/419,229

(22) Filed: Dec. 15, 2025

Related U.S. Application Data
(60) Provisional application No. 63/758,624, filed on Feb. 14, 2025.

(51) Int. Cl. C09D 5/18; C09D 4/06; C09D 7/63; C09D 7/65; C09D 125/18

(52) U.S. Cl. CPC C09D 5/18; C09D 4/06; C09D 7/63; C09D 7/65; C09D 125/18; C08G 2150/60

(57) ABSTRACT

Disclosed is a thermoset composition comprising (a) a film-forming component comprising a reaction product of reactants comprising a phenol-containing compound and a phthalonitrile-containing compound and (b) a blowing agent comprising eumelanin and/or a hydrophilic lignin. Also disclosed are methods of forming the thermoset compositions. Also disclosed are substrates comprising a coating formed from the thermoset compositions. Also disclosed are articles formed from the thermoset compositions.

### CROSS-REFERENCE TO RELATED APPLICATION

This application claims priority to U.S. Provisional Application No. 63/758,624, filed on Feb. 14, 2025, entitled “Polymer Foam Comprising Phthalonitrile-Based Resins and Carboxylate-Containing Blowing Agents and Methods of Preparing Same,” incorporated herein in its entirety.

### GOVERNMENT CONTRACT

The disclosure described and claimed herein was made under a Cooperative Research and Development Agreement with the United States Navy, NCRADA-NAWCWDCL-20-290. The United States Government has certain rights in this disclosure.

### FIELD

The present disclosure is directed to phthalonitrile-based compositions and methods of producing same.

### BACKGROUND

Thermosetting polymer foams have generated interest due to their superior performance characteristics, such as chemical resistance, strength-to-weight ratio, structural tunability and structural integrity retention at elevated temperatures in aerospace applications. Most polymers used in foam preparation are derived from petroleum refining, which is a concern due to climate change and the environmental pollution from petroleum production. To address this concern, bio-enabled polymers have been developed as a full or partial replacement that are made from renewable biomass materials such as cellulose, lignin, starch, pectin, chitin, and xylan.

### SUMMARY

The present disclosure is directed to a thermoset composition comprising: a film-forming component comprising a reaction product of reactants comprising a phenol-containing compound and a phthalonitrile-containing compound; and a blowing agent comprising eumelanin and/or a hydrophilic lignin.

Also disclosed are methods of making any of the thermoset compositions disclosed herein.

Also disclosed are substrates comprising a coating formed from any of the thermoset compositions on a surface thereof.

Also disclosed are articles formed from any of the thermoset compositions in a cured state.

Also disclosed are foams formed from any of the thermoset compositions in a cured state.

### BRIEF DESCIPTION OF THE DRAWINGS

FIG. 1 is a diagram illustrating a comparison in the performance of a foam of the present disclosure (left) compared to a commercially available foam (right) after exposure to a flame.

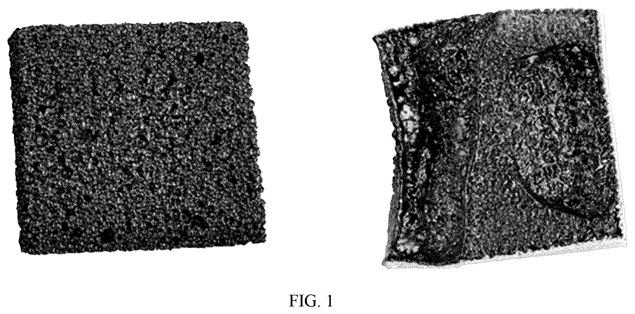

FIG. 2 is a graph showing Fourier Transform Infrared spectra that illustrate structural differences between hydrophobic (Indulin AT lignin from Ingevity) and hydrophilic (KRAFT lignin from Millipore Sigma).

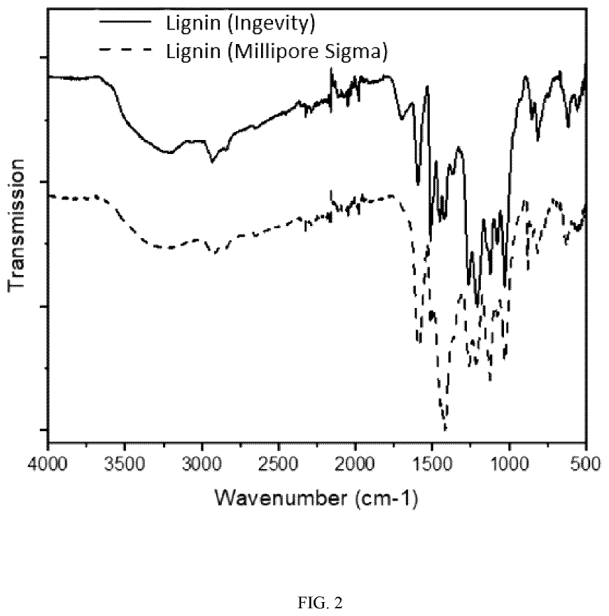

FIG. 3 is a thermogravimetric analysis plot that illustrates thermal behavior different between hydrophobic (Indulin AT lignin from Ingevity) and hydrophilic (KRAFT lignin from Millipore Sigma).

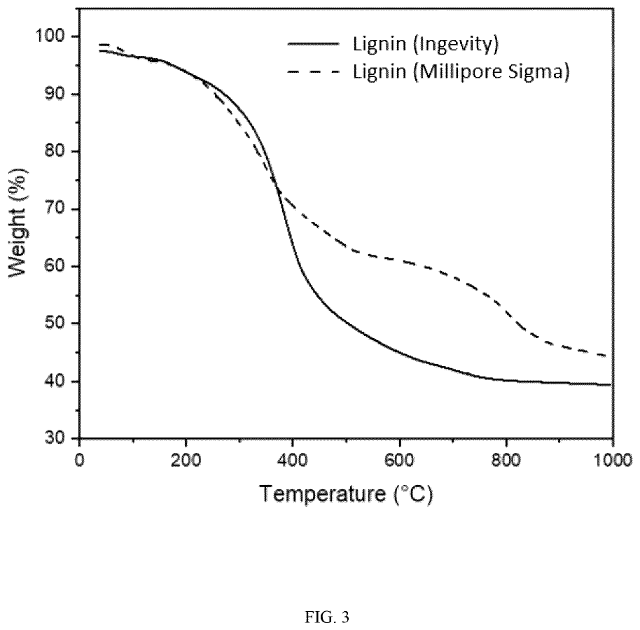

FIG. 4 are images showing water dispersibility differences between hydrophilic (KRAFT lignin from Millipore Sigma) and hydrophobic (Indulin AT lignin from Ingevity).

FIG. 5 are images showing the water droplet interaction differences between hydrophobic lignin (Indulin AT lignin from Ingevity) and hydrophilic lignin (KRAFT lignin from Millipore Sigma).

### DETAILED DESCRIPTION

The present disclosure is directed to a thermoset composition comprising, or consisting essentially of, or consisting of: a film-forming component comprising a reaction product of reactants comprising a phenol-containing compound and a phthalonitrile-containing compound; and a blowing agent comprising eumelanin and/or a hydrophilic lignin. As used herein, “thermoset” refers to a liquid composition or soft solid that is irreversibly hardened by curing.

The composition may comprise a film-forming component. As used herein, “film-forming,” “film former,” and the like refer to a composition that, upon hardening and/or curing, can form a continuous film on a surface, a continuous defined shape within a closed or open mold cavity, or a continuous film or continuous defined shape due to other means of confinement, such as within the boundaries of one phase of a multi-phase structure, for example, within the micelles of an emulsion or by a pattern-forming means of confinement such as photo-lithography. The film-forming component may comprise, for example, a film-forming resin and/or a film-forming polymer and a crosslinker thereof. “Polymer” refers to prepolymers, oligomers, homopolymers, and copolymers; the prefix “poly” refers to two or more.

The composition may comprise the phenol-containing compound and the phthalonitrile-containing compound in reactive equivalent ratio of at least 0.9:1, such as at least 1:1, such as at least 1.05:1. The composition may comprise the phenol-containing compound and the phthalonitrile-containing compound in reactive equivalent ratio of no more than 2:1, such as no more than 1.5:1, such as no more than 1.1:1. The composition may comprise the phenol-containing compound and the phthalonitrile-containing compound in reactive equivalent ratio of 0.9:1 to 2:1, such as 1:1 to 1.5:1, such as 1.05:1 to 1.1:1.

### Phenol-Containing Compounds

The reactants comprise a phenol-containing compound. Examples of phenol-containing compounds include bio-enabled phenol-containing compounds. The phenol-containing compound may be a polyphenolic compound. In this embodiment ‘poly’ refers to more than one functionality. The phenol-containing compound may be a diphenolic compound.

As used herein, “phenol-containing compound” refers to a compound having a hydroxyl group linked directly to a benzene ring.

The phenol-containing compound may comprise bio-enabled phenols or a mixture of phenols, including but not limited to resveratrol, catechol, hydroxytyrosol, eugenol, and mixtures thereof. The phenol-containing compound may comprise petroleum-based phenols, including but not limited to bisphenol A, bisphenol M, bisphenol P, bisphenol E, bisphenol F, bisphenol S, and mixtures thereof. The phenol-containing compound may further comprise other active hydrogen compounds, such as monophenols and/or benzyl-alcohols. The phenol-containing compound may be bio-enabled. As used herein “bio-enabled” refers to a material having chemical structures discovered in, duplicated or derived from, or produced in whole or in part, through biological systems.

Examples of suitable bio-enabled phenols include phenols based on Magnolia species extracts, such as magnolol (3′,5-diallyl-[1,1′-biphenyl]-2,4′-dioxy) and its isomer honokiol (5,5′-diallyl-[1,1′-biphenyl]-2,2′diol) and mixtures thereof. The phenol-containing compound may comprise a single Magnolia extract species or a mixture thereof. As used herein “Magnolia extract” refers to a mixture of magnolol and honokiol obtained from the biological source of Magnolia officinalis. Examples of suitable bio-enabled phenols also include resveratrol (3,5,4′-trihydroxystilbene). The phenol-containing compound may comprise magnolol (3′,5-diallyl-[1,1′-biphenyl]-2,4′-dioxy), honokiol (5,5′-diallyl-[1,1′-biphenyl]-2,2′diol), and/or resveratrol (3,5,4′-trihydroxystilbene), including the cis- and/or trans-forms of 3,5,4′-trihydroxystilbene.

The phenol-containing compound may comprise a mixture of magnolol and honokiol in a weight ratio of at least 1:99, such as at least 20:80, such as at least 40:60. The phenol-containing compound may comprise a mixture of magnolol and honokiol in a weight ratio of no more than 99:1, such as no more than 80:20, such as no more than 60:40. The phenol-containing compound may comprise a mixture of magnolol and honokiol in a weight ratio of 1:99 to 99:1, such as 20:80 to 80:20, such as 40:60 to 60:40.

The phenol-containing compound may further comprise monofunctional and/or polyfunctional phenols and/or benzyl alcohol.

The phenol-containing compound may comprise a functional group in addition to the hydroxyl functional group. For example, the phenol-containing compound may comprise other functional groups, including but not limited to an alkyl group, an alkenyl, an alkynyl, a cycloaliphatic or aromatic group, or mixtures thereof.

### Phthalonitrile-Containing Compounds

The reactants comprise a phthalonitrile-containing compound. Examples of phthalonitrile-containing compounds include 3-nitrophthalonitrile and 4-nitrophthalonitrile. As used herein, “3-nitrophthalonitrile” refers to a phthalonitrile having nitrile groups in positions ortho- and meta-to a non-nitrile functional group, such as a nitro group. As used herein, “4-nitrophtahlonitrile” refers to a phthalonitrile having nitrile groups in positions para- and meta-to a non-nitrile functional group, such as a nitro group.

### Reaction Products

The reaction product formed from the reactants comprising the phenol-containing compound and the phthalonitrile-containing compound may comprise a monomer, a prepolymer, and/or a polymer. The reaction product may comprise a compound comprising a residue of phenol and a phthalonitrile functional group. As used herein, “residue” refers to the portion of a given compound that remains after the compound undergoes a reaction.

As used herein, “monomer” refers to a molecule with two or more binding sites through which it may form covalent linkages with other monomer molecules to form a prepolymer or a polymer. As used herein, “prepolymer” refers to a molecule that is formed by the partial polymerization of a monomer or a group of monomers. As used herein, “polymer” refers to a molecule made of repeating units derived from one or more species of monomers. Examples of polymers include oligomers, homopolymers, and copolymers.

The reaction product may further comprise reactive functional groups in addition to the phthalonitrile and/or phenol functional group. Examples of additional functional groups include alkyl, alkenyl, alkynyl, aryl, benzyl, cyanate ester, epoxy, benzoxazine, and maleimide functional groups. Such reactive functional groups may crosslink molecules together when heated at temperatures greater than ambient, such as at temperatures of at least 50° C., such as at least 75° C., such as at least 100° C., such as at least 200° C., such as at least 300° C., or up to 400° C., for time periods of at least 5 minutes, such as at least 30 minutes, such as at least 1 hour, such as at least 5 hours, such as at least 10 hours, such as at least 24 hours, such as at least 48 hours, such as at least 72 hours, such as at least 96 hours, such as up to 30 days.

The reaction product may comprise a number average molecular weight of at least 200 g/mol, such as at least 300 g/mol, such as at least 450 g/mol. The reaction product may comprise a number average molecular weight of no more than 2,000 g/mol, such as no more than 1,000 g/mol, such as no more than 800 g/mol, such as no more than 700 g/mol. The reaction product may comprise a number average molecular weight of 200 g/mol to 2,000 g/mol, such as 200 g/mol to 1,000 g/mol, such as 300 g/mol to 800 g/mol, such as 450 g/mol to 700 g/mol. Number average molecular weight may be measured by mass spectrometry or gel permeation chromatography (polystyrene standards in THF) or may be calculated theoretically.

The reaction product may comprise a combination of functional groups that are capable of reacting with each other (self-crosslinking) and functional groups that are reactive with the functional groups of the blowing agent and/or curing agent.

The reaction product comprises an average of one or more phthalonitrile-functional groups, such as an average of at least two phthalonitrile-functional groups, such as an average of at least three phthalonitrile-functional groups, such as an average of at least four phthalonitrile-functional groups. The reaction product may comprise an average of one to four phthalonitrile-functional groups, such as two to three phthalonitrile-functional groups.

One suitable reaction scheme for making the reaction product includes the reaction shown in Reaction Scheme I, comprising the reaction of a phenol-containing compound and a phthalonitrile-containing compound under conditions as described in the Examples:

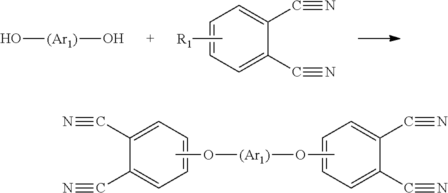

wherein Ar₁ is an aromatic group and wherein R₁ is a functional group comprising a nitro group.

Suitable reaction products resulting from the reaction of a phenol-containing compound and a phthalonitrile-containing compound include those shown in Structures I to III:

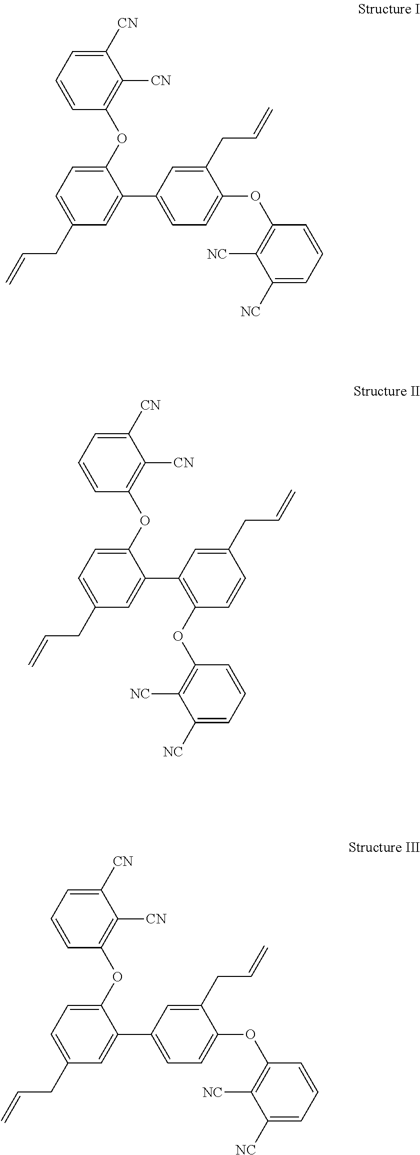

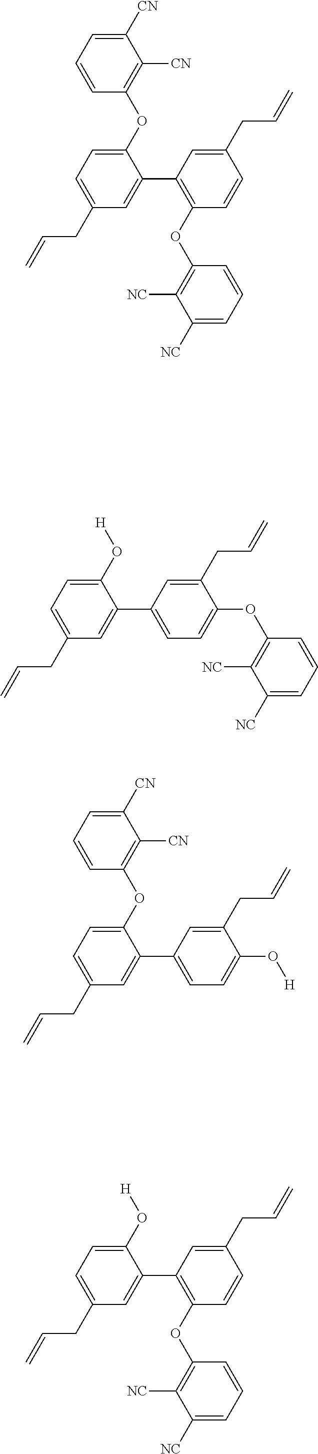

The reaction product may have a melt viscosity of less than 100,000 centipoises (cP) measured utilizing a rheometer or a viscometer with Thermosel.

The reaction product may have a melt viscosity of more than 100,000 centipoises (cP) measured utilizing a rheometer or a viscometer with Thermosel.

The composition may comprise the reaction product in an amount of at least 30 percent by weight based on total weight of the composition, such as at least 50 percent by weight. The composition may comprise the reaction product in an amount of no more than 99.9 percent by weight based on total weight of the composition, such as no more than 99 percent by weight. The composition may comprise the reaction product in an amount of 30 percent by weight to 99.9 percent by weight based on total weight of the composition, such as 50 percent by weight to 99 percent by weight.

### Blowing Agents

The blowing agent comprises eumelanin and/or a hydrophilic lignin (described below). The composition may further comprise a physical blowing agent. The blowing agent may be a molecule comprising repeat units, such as an oligomer or a polymer. The blowing agent may have a number average molecular weight of more than 2,000 g/mol measured according to gel permeation chromatography and/or mass spectrometry or calculated theoretically. The blowing agent may undergo decarboxylation, i.e., CO2 release, at temperatures of around 200° C. As used herein, “blowing agent” refers to any agent which produces voids in the film-forming matrix during polymerization.

The blowing agent may comprise any compound comprising a carboxylate group. The blowing agent may comprise more than one carboxylate group. The blowing agent may further comprise an active hydrogen group(s). Examples of functional groups with an active hydrogen include amines and hydroxyls. The blowing agent may be a linear or branched structure in which the carboxylate group is present either in the backbone of the molecule or as a side group. The blowing agent may have a polydispersity index of more than 1, as measured by gel permeation chromatography, mass spectrometry, dynamic light scattering or centrifugation techniques. The blowing agent may comprise aromatic and/or conjugated groups, such as phenyl groups. The blowing agent may comprise an active hydrogen group linked directly to an aromatic ring. The blowing agent may be chemically-derived, bio-based, or bio-derived.

Examples of blowing agents include bio-derived polymers, such as lignin and melanin. Examples of bio-derived melanin may include eumelanin. In addition to the carboxylic acid-containing polymeric and/or oligomeric blowing agent, the blowing agent may further comprise a small molecule blowing agent comprising carboxylate moieties, such as protocatechuic acid, gallic acid, and tannic acid. The term “carboxylate” moiety refers to a fragment of an organic molecule containing at least one functional group with a —COO— core structure, including but not limited to ester, carboxylic acid, carboxylate functional groups, or a mixture thereof. In preferred embodiments, the carboxylate moiety is selected by those skilled in the art of organic reaction chemistry to facilitate the release of carbon dioxide at a temperature that corresponds to a favorable point in the phthalonitrile cure process for the formation of foams with one or more desirable characteristics, such as cell size, crush strength, thermochemical stability, char-forming ability, or adhesion to an adjacent adherend. For example, the aromatic ring in certain carboxylate containing blowing agents facilitates the release of carbon dioxide at temperatures near 200-250° C., a temperature where significant cure of phthalonitrile-containing resins may take place. In some cases, the release of carbon dioxide generates hydroxyl-containing structures, which may plasticize and/or catalyze the phthalonitrile crosslinking reaction, and initiate further cure of phthalonitrile resins that are difficult to completely cure. Furthermore, from a processing standpoint, the in situ generation of such cure-capable structures during cure may compare favorably to addition of curatives prior to cure, due to the volatility and toxicity of certain curing agents. The favorability of temperature and other process characteristics for producing such foams may be determined by those skilled in the art of reactive polymer processing and foam production.

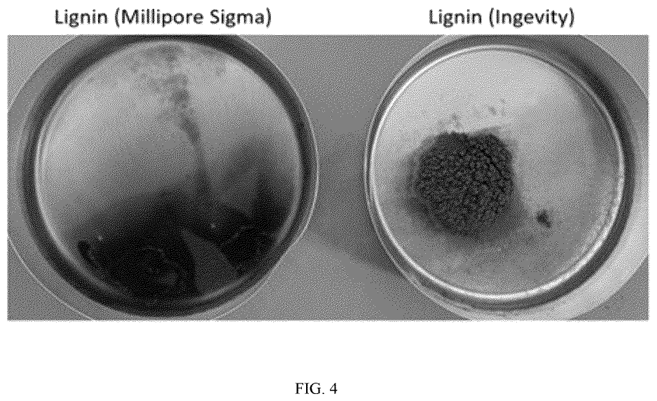

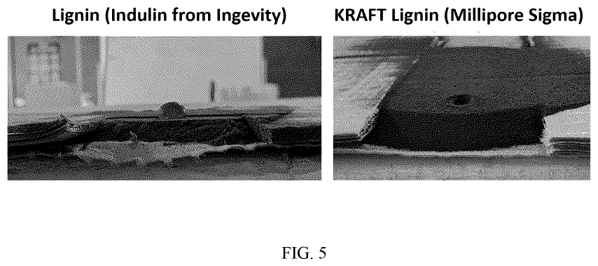

Polymer and/or oligomer based blowing agents, such as eumelanin and lignin, may comprise powder with specific surface energy characteristics. For example, the powder might be hydrophilic or hydrophobic in nature. As used herein, the term “hydrophobic” refers to substances that are not readily dispersible in water and/or do not form uniform dispersions in water. Additionally, as used herein “hydrophobic” substances do not readily absorb water droplets and/or do not spread out thinly across the surface. As used herein, “hydrophilic powder” may be readily dispersible in water, whereas hydrophobic powder is preferentially dispersible in organic resin components and not water dispersible. Surface energy characteristics, such as hydrophobicity, might be achieved by certain surface treatments or surface coatings. For example, lignin is available as both hydrophilic and hydrophobic powder. The differences between lignin in a hydrophilic and hydrophobic powder state are shown in FIGS. 4 and 5. Hydrophobic powder may also be referred to as “free-flowing powder”.

Hydrophobic powder may be selected by those skilled in the art to achieve more uniform distribution and improved mixing of the blowing agent in the film-forming component. Improved distribution of the blowing agent in the film-forming component may result and/or a more uniform decarboxylation reaction. This may further lead to a different morphology and cell size of the foams. The cell size may be smaller with a more homogeneous distribution. If the blowing agent is not uniformly distributed, side reactions can occur during the foam preparation process and result in undesirable foam characteristics, such as bad odor or heterogenous morphology. Hydrophilic powder may be selected by those skilled in the art when foams with more heterogeneous characteristics, such as cell size or distribution, are desired.

The blowing agent may further comprise a functional group in addition to the carboxylate group and, optionally, an active hydrogen group. For example, the blowing agent may further comprise a urethane group, an alkyl group, an alkenyl group, an alkynyl group, an amide group, and/or an ether group. The blowing agent may further comprise a thermosetting functional group, such as a phthalonitrile group and/or an epoxy group.

The blowing agent may be substantially free, or essentially free, or completely free, of functional groups other than the carboxylate group. That is, the blowing agent may be substantially free, or essentially free, or completely free, of thermosetting functional groups such as phthalonitrile groups or epoxy groups.

The composition may comprise the blowing agent in an amount of at least 0.1 percent by weight based on total weight of the composition, such as at least 1 percent by weight. The composition may comprise the blowing agent in an amount of no more than 70 percent by weight based on total weight of the composition, such as no more than 50 percent by weight. The composition may comprise the blowing agent in an amount of 0.1 percent by weight to 70 percent by weight based on total weight of the composition, such as 1 percent by weight to 50 percent by weight.

### Additional Ingredients

The composition may further comprise a curing agent in addition to the phthalonitrile-containing compound. The curing agent may comprise a phenol, an amine, an organic acid, and/or an organometallic compound. The composition may comprise the curing agent in an amount of at least 1 percent by weight based on total weight of the composition, such as at least 5 percent by weight. The composition may comprise the curing agent in an amount of no more than 50 percent by weight based on total weight of the composition, such as no more than 45 percent by weight. The composition may comprise the curing agent in an amount of 1 percent by weight to 50 percent by weight based on total weight of the composition, such as 5 percent by weight to 45 percent by weight.

The composition may be substantially free, or essentially free, or completely free, of curing agent in addition to the phthalonitrile-containing compound.

The composition may further comprise a catalyst, such as a transition metal catalyst. The composition may comprise the catalyst in an amount of at least 0.1 percent by weight based on total weight of the composition, such as at least 1 percent by weight. The composition may comprise the catalyst in an amount of no more than 10 percent by weight based on total weight of the composition, such as no more than 5 percent by weight. The composition may comprise the catalyst in an amount of 0.1 percent by weight to 10 percent by weight based on total weight of the composition, such as 1 percent by weight to 5 percent by weight.

The composition may further comprise a particulate additive which may serve as any combination of filler, reinforcement, viscosity modifier, surface modifier, processing aid, fire retardant, thermal stability enhancer, pyrolysis aid, or graphitization aid. Examples of additives include carbon and/or inorganic microstructures, and/or nanostructures such as carbon black, graphite, boron nitride or silica particles.

In addition to particulate additives, non-particulate additives that serve as any combination of extender, polymerization reaction control agent, diluent, gas liberation control agent, surface modifier, mechanical property modifier, or appearance modifier may be added.

The composition may further comprise a surfactant. Examples of surfactants include carbon-based and silicone-based surfactants. The composition may comprise the surfactant in an amount of at least 0.01 percent by weight based on total weight of the composition, such as at least 0.05 percent by weight. The composition may comprise the surfactant in an amount of no more than 10 percent by weight based on total weight of the composition, such as no more than 5 percent by weight. The composition may comprise the surfactant in an amount of 0.01 percent by weight to 10 percent by weight based on total weight of the composition, such as 0.5 percent by weight to 5 percent by weight.

The composition may be substantially free, or essentially free, or completely free, of surfactant.

The composition may further comprise a foam stabilizer. Examples of foam stabilizers include Varosurf DC-193, Shin-Etsu CAT-1310, and KE-1310ST.

The composition may be substantially free, or essentially free, or completely free, of foam stabilizer.

The composition may further comprise a filler. Examples of filler include alumina, fumed silica, precipitated silica, boron nitride, carbon black or other carbon filler, polyhedral oligomeric silsesquioxanes, bio-enabled polymers, or other thermosetting and thermoplastic polymer additives, and various fibers.

The composition may comprise the filler in an amount of at least 0.1 percent by weight based on total weight of the composition, such as at least 5 percent by weight. The composition may comprise the filler in an amount of no more than 50 percent by weight based on total weight of the composition, such as no more than 40 percent by weight. The composition may comprise the filler in an amount of 0.1 percent by weight to 50 percent by weight based on total weight of the composition, such as 5 percent by weight to 40 percent by weight.

The composition may be substantially free, or essentially free, or completely free, of filler.

The composition may be substantially free, or essentially free, or completely free, of an azo-derived blowing agent.

### Preparation of the Film-Forming Component

The reaction product and the blowing agent, each described above, may be reacted to form a foam. One suitable reaction scheme for making a foam includes the reaction shown in Reaction Scheme II, comprising the reaction of a reaction product described above and a blowing agent described above:

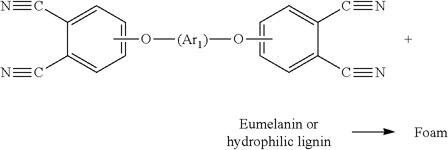

The film-forming component comprising the reaction product described above may be prepared by chemical reactions and purification methods known to those skilled in the art. For example, the film-forming component comprising the reaction product may be processed by dry blending, melt mixing, casting, extrusion, injection, or other suitable methods of providing a desired geometrical configuration. The selection and utilization of these methods are apparent to those skilled in the art of processing thermosetting resin materials.

The thermosetting foam may be prepared by heating the film-forming component and the blowing agent, resulting in polymerization of the components to create a crosslinked solid as well as liberation of gas to create a foam. The parameters and timing of these processes may be adjusted to obtain the desired physical and morphological characteristics of the foam as practiced by those skilled in the art of processing thermosetting foam materials.

The formation of the thermoset foam may be carried out as a stand-alone batch or continuous activity, yielding a separate foam product. The formation of the thermoset foam may be carried out as part of an integrated assembly process. For example, a sandwich structure, comprising one or more layers of pre-impregnated reinforced woven composite fibers (herein referred to as “prepreg”), topped by a layer of adhesive, topped by a layer of foam precursor, topped by another layer of adhesive, and finally, topped by one or more layers of prepreg, may be prepared and then heated, in the process curing the resin in the prepreg, setting the adhesive, and generating the foam, with the resultant structure being an integrated composite “sandwich panel” useful as a lightweight, thermally-resistant, thermally insulating structure. The available range of processing routes and combinations of foam and other integrated materials to produce articles of value are apparent to those skilled in the art of composite article fabrication.

The thermosetting foams and their integrated structures may be useful as stand-alone thermal insulation capable of withstanding elevated temperatures for long periods with limited extents of chemical degradation and release of hazardous substances.

The thermosetting foams and their integrated structures may further be useful as lightweight, fire-resistant structural composites having extended durability at elevated temperatures during use, for applications such as ships, aircraft, and spacecraft structures or insulation.

The thermosetting foams and their integrated structures may further be useful as precursors to graphitic or ceramic structures that combine low density, mechanical strength, and resistance to extremely high temperatures for extended periods, for use in ships, aircraft, or spacecraft structures or insulation.

### Methods of Coating Substrates

The present disclosure is further directed to a method for using the thermosetting foam compositions, to coat a substrate, comprising applying the composition, film, and/or sheet to at least a portion of the substrate. “Applying,” “applied to,” and any variants thereof, when referring to the coating composition, means coating with and, when referring to the film or sheet, means that the film/sheet can be affixed or attached to the substrate, such as by use of an adhesive, and/or positioned adjacent to the substrate. “Applying” therefore includes placing a self-supported film and/or sheet adjacent to a surface of an article. The aforementioned “substrate” may also comprise one or more mold cavities, pre-formed shapes, matched or mated surfaces, surface replicas, or transfer surfaces. These particular substrate forms may be useful for fabrication of foam articles by methods involving casting, pouring, molding, or releasing steps. The present disclosure is further directed to a method of constructing sandwich structures, where the thermosetting foams are used in conjunction with a composite substrate.

### Foams

The foams formed from the compositions disclosed herein unexpectedly demonstrated at least one of the following characteristics:
(a) Tg of at least 250° C., such as at least 300° C., such as at least 350° C.;
(b) a char yield of at least 60%, such as at least 70%; and/or
(c) fire resistance.

As a result, these foams may be utilized for thermal and acoustic insulation, for fire protection, and/or as structural materials in aerospace, automotive and marine applications. “Fire resistant”, “fire resistance” and like terms is used herein to describe the present composition as well as coatings or coating layers deposited from the composition. “Fire resistant” and “fire resistance” means that a coating layer, when deposited onto or applied on a substrate and cured and then exposed to a flame, the coating does not ignite or sustain a flame. A coating “ignites” if it continues burning once the flame is removed.

The foams may be useful as precursors to carbonaceous or other ceramic compositions when subjected to thermal treatments at temperatures of 1000° C. or higher.

### Substrates

Compositions described herein may be coated or deposited on, or otherwise contacted with, any substrate or surface, such as, but not limited to, metals or metal alloys, polymeric materials, such as plastics including filled and unfilled thermoplastic or thermoset materials, and/or composite materials. Other examples of substrates include, but are not limited to, glass or natural materials such as wood. Substrates may include two or more of any different materials in any combination, such as, but not limited to, two different metals, or a metal and a metal alloy, or a metal and a metal alloy and one or more composite materials.

### Definitions

For purposes of this detailed description, it is to be understood that the disclosure may assume alternative variations and step sequences, except where expressly specified to the contrary.

The numerical values set forth in the specific examples are reported as precisely as possible. Any numerical value, however, inherently contains certain errors necessarily resulting from the standard variation found in their respective testing measurements.

Also, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “a” phenol, and “a” phthalonitrile, a combination (i.e., a plurality) of these components may be used.

In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on,” “deposited onto,” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

As used herein, a “composition” or a “foam composition” refers to a solution, mixture, or a dispersion that is capable of producing a coating on a substrate surface. “Coating” as used herein includes films, layers and the like.

As further defined herein, ambient conditions generally refer to room temperature (e.g., 23° C.) and humidity conditions or temperature and humidity conditions that are typically found in the area in which the composition is applied to a substrate, e.g., at 10° C. to 40° C. and 5% to 80% relative humidity, while slightly thermal conditions are temperatures that are slightly above ambient temperature, but are generally below the curing temperature for the composition (i.e., in other words, at temperatures and humidity conditions below which the reactive components will readily react and cure, e.g., >40° C. and less than 220° C. at 20% to 80% relative humidity).

As used herein, the term “cure,” “curing,” and similar terms, means that the components that form the composition are crosslinked (i.e., interact and/or react) to form a coating or a bond.

The term “curable,” as used in connection with a coating composition, means that the composition is able to be cured under ambient and/or slightly thermal conditions.

As used herein, “Mn” refers to the number average molecular weight, for example the theoretical value, or experimental value as determined by mass spectrometry or Gel Permeation Chromatography using Waters 2695 separation module with a Waters 410 differential refractometer (RI detector), polystyrene standards, using tetrahydrofuran (THF) as the eluent at a flow rate of 1 mL min-1 and two PL Gel Mixed C columns for separation.

As used herein, “small molecule” refers to a molecule that comprises discrete chemical structures, and has a number average molecular weight of less than 2,000 g/mol. The number average molecular weight of a small molecule may be determined by mass spectrometry or may be a calculated theoretical value.

As used herein, unless indicated otherwise, the term “substantially free” means that a particular material is not purposefully added to a mixture or composition, respectively, and is only present as an impurity in a trace amount of less than 0.05% by weight based on a total weight of the mixture or composition, respectively. As used herein, unless indicated otherwise, the term “essentially free” means that a particular material is only present in an amount of less than 0.01% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material.

In view of the foregoing description the present disclosure thus relates in particular to the following Aspects 1 to 60 without being limited thereto.

Aspects of the disclosure include:

Aspect 1. A thermoset composition, comprising:
a film-forming component comprising a reaction product of reactants comprising a phenol-containing compound and a phthalonitrile-containing compound; and
a blowing agent comprising eumelanin and/or a hydrophilic lignin.

Aspect 2. The composition of aspect 1, wherein the reaction product comprises a compound comprising a residue of a phenol and a phthalonitrile functional group.

Aspect 3. The composition of aspect 1 or aspect 2, comprising the phenol-containing compound and the phthalonitrile-containing compound in a reactive equivalent ratio of at least 0.9:1, such as at least 1:1.

Aspect 4. The composition of any preceding aspect, comprising the phenol-containing compound and the phthalonitrile-containing compound in a reactive equivalent ratio of at least 1.05:1.

Aspect 5. The composition of any preceding aspect, comprising the phenol-containing compound and the phthalonitrile-containing compound in a reactive equivalent ratio of no more than 2:1, such as no more than 1.5:1.

Aspect 6. The composition of any preceding aspect, comprising the phenol-containing compound and the phthalonitrile-containing compound in a reactive equivalent ratio of no more than 1.1:1.

Aspect 7. The composition of any preceding aspect, comprising the phenol-containing compound and the phthalonitrile-containing compound in a reactive equivalent ratio of 0.9:1 to 2:1, such as 1:1 to 1.5:1.

Aspect 8. The composition of any preceding aspect, comprising the phenol-containing compound and the phthalonitrile-containing compound in a reactive equivalent ratio of 1.05:1 to 1.1:1.

Aspect 9. The composition of any of the preceding aspects, wherein the phenol-containing compound comprises a diphenolic compound.

Aspect 10. The composition of any preceding aspect, wherein the phenol-containing compound and/or the blowing agent comprises a bio-enabled compound.

Aspect 11. The composition of any preceding aspect, wherein the phenol-containing compound comprises resveratrol, magnolol, honokiol, and/or Magnolia extract.

Aspect 12. The composition of any preceding aspect, wherein the phenol-containing compound comprises magnolol and honokiol in a ratio of at least 1:99, such as at least 20:80.

Aspect 13. The composition of any preceding aspect, wherein the phenol-containing compound comprises magnolol and honokiol in a ratio of at least 40:60.

Aspect 14. The composition of any preceding aspect, wherein the phenol-containing compound comprises magnolol and honokiol in a ratio of no more than 99:1, such as no more than 80:20.

Aspect 15. The composition of any preceding aspect, wherein the phenol-containing compound comprises magnolol and honokiol in a ratio of no more than 60:40.

Aspect 16. The composition of any preceding aspect, wherein the phenol-containing compound comprises magnolol and honokiol in a ratio of 1:99 to 99:1, such as 20:80 to 80:20.

Aspect 17. The composition of any preceding aspect, wherein the phenol-containing compound comprises magnolol and honokiol in a ratio of 40:60 to 60:40.

Aspect 18. The composition of any preceding aspect, wherein the phenol-containing compound comprises a functional group in addition to the hydroxyl group, such as an alkyl group, an alkenyl group, an alkynyl group, a cycloaliphatic group, and/or an aromatic group.

Aspect 19. The composition of any preceding aspect, wherein the phthalonitrile-containing compound comprises 3-nitrophthalonitrile and/or 4-nitrophthalonitrile.

Aspect 20. The composition of any preceding aspect, wherein the reaction product comprises an Mn of at least 200 g/mol, such as at least 300 g/mol measured according to gel permeation chromatography and/or mass spectrometry or calculated theoretically.

Aspect 21. The composition of any preceding aspect, wherein the reaction product comprises an Mn of at least 450 g/mol measured according to gel permeation chromatography and/or mass spectrometry or calculated theoretically.

Aspect 22. The composition of any preceding aspect, wherein the reaction product comprises an Mn of no more than 2,000 g/mol, such as no more than 1,000 g/mol measured according to gel permeation chromatography and/or mass spectrometry or calculated theoretically.

Aspect 23. The composition of any preceding aspect, wherein the reaction product comprises an Mn of no more than 800 g/mol, such as no more than 700 g/mol measured according to gel permeation chromatography and/or mass spectrometry or calculated theoretically.

Aspect 24. The composition of any preceding aspect, wherein the reaction product comprises an Mn of 200 g/mol to 2,000 g/mol, such as 200 g/mol to 1,000 g/mol measured according to gel permeation chromatography and/or mass spectrometry or calculated theoretically.

Aspect 25. The composition of any preceding aspect, wherein the reaction product comprises an Mn of such as 300 g/mol to 800 g/mol, such as 450 g/mol to 700 g/mol measured according to gel permeation chromatography and/or mass spectrometry or calculated theoretically.

Aspect 26. The composition of any preceding aspect, wherein the reaction product comprises an average of one or more phthalonitrile functional groups, such as an average of at least two phthalonitrile functional groups.

Aspect 27. The composition of any preceding aspect, wherein the reaction product comprises an average of at least three phthalonitrile functional groups, such as an average of at least four phthalonitrile functional groups.

Aspect 28. The composition of any preceding aspect, wherein the reaction product comprises an average of one to four phthalonitrile functional groups, such as two to three phthalonitrile functional groups.

Aspect 29. The composition of any preceding aspect, wherein the reaction product comprises a functional group in addition to the phthalonitrile functional group.

Aspect 30. The composition of aspect 29, wherein the additional functional group comprises an alkyl functional group, an alkenyl functional group, an alkynyl functional group, an aryl functional group, a benzyl functional group, a cyanate ester functional group, an epoxy functional group, a benzoxazine functional group, and/or a maleimide functional group.

Aspect 31. The composition of any preceding aspect, wherein the reaction product comprises a low melt viscosity of less than 100,000 centipoises.

Aspect 32. The composition of any preceding aspect, wherein the reaction product comprises a high melt viscosity of more than 100,000 centipoises.

Aspect 33. The composition of any preceding aspect, wherein the reaction product is formed according to Reaction Scheme I:

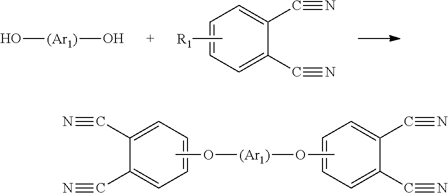

Aspect 34. The composition of any preceding aspect, wherein the reaction product comprises Structure I, Structure II, and/or Structure III:

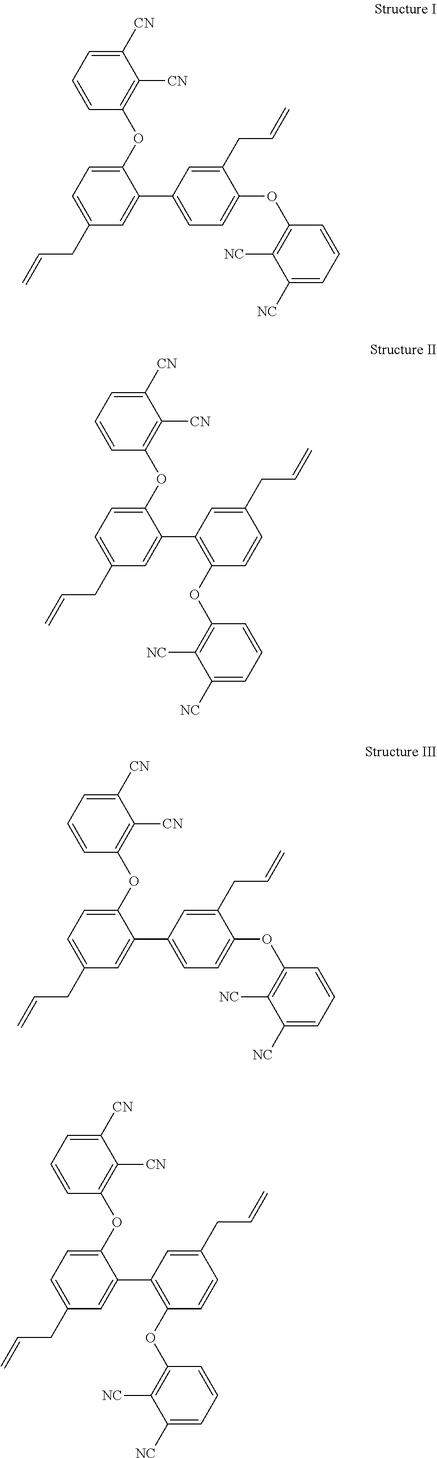

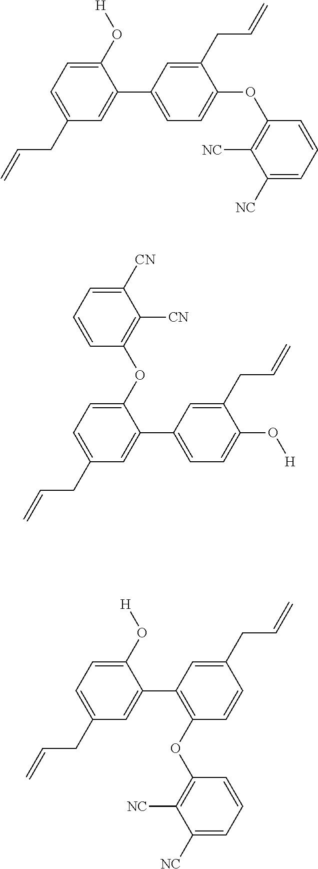 [SMILES: C=CCc1ccc(O)c(-c2ccc(Oc3cccc(C#N)c3C#N)c(CC=C)c2)c1 ; C=CCc1ccc(Oc2cccc(C#N)c2C#N)c(-c2ccc(O)c(CC=C)c2)c1 ; C=CCc1ccc(O)c(-c2cc(CC=C)ccc2Oc2cccc(C#N)c2C#N)c1]

Aspect 35. The composition of any preceding aspect, wherein the blowing agent comprises an ester, a carboxyl, a carboxylate, or a mixture thereof.

Aspect 36. The composition of any preceding aspect, wherein the blowing agent comprises a hydroxyl functional group.

Aspect 37. The composition of any preceding aspect, wherein the blowing agent is an oligomer or a polymer.

Aspect 38. The composition of any preceding aspect, comprising the reaction product in an amount of at least 30 percent by weight based on total weight of the composition, such as at least 50 percent by weight.

Aspect 39. The composition of any preceding aspect, comprising the reaction product in an amount of no more than 99.9 percent by weight based on total weight of the composition, such as no more than 99 percent by weight.

Aspect 40. The composition of any preceding aspect, comprising the reaction product in an amount of 30 percent by weight to 99.9 percent by weight based on total weight of the composition, such as 50 percent by weight to 99 percent by weight.

Aspect 41. The composition of any preceding aspect, comprising the blowing agent in an amount of at least 0.1 percent by weight based on total weight of the composition, such as at least 1 percent by weight.

Aspect 42. The composition of any preceding aspect, comprising the blowing agent in an amount of no more than 70 percent by weight based on total weight of the composition, such as no more than 50 percent by weight.

Aspect 43. The composition of any preceding aspect, comprising the blowing agent in an amount of 0.1 percent by weight to 70 percent by weight based on total weight of the composition, such as 1 percent by weight to 50 percent by weight.

Aspect 44. The composition of any preceding aspect further comprising a curing agent, such as a phenol, an amine, an organic acid, and/or an organometallic compound.

Aspect 45. The composition of any preceding aspect, comprising the curing agent in an amount of 1 percent by weight to 50 percent by weight based on total weight of the composition, such as 5 percent by weight to 45 percent by weight.

Aspect 46. The composition of any of the preceding aspects 1 to 45, wherein the composition is substantially free of a curing agent.

Aspect 47. The composition of any preceding aspect, further comprising a surfactant, a foam stabilizer, a filler, and/or a catalyst such as a transition metal catalyst.

Aspect 48. The composition of any preceding aspect, wherein the composition is substantially free of a surfactant, a foam stabilizer, and/or an azo-derived blowing agent.

Aspect 49. The composition of any preceding aspect, wherein the reaction product and the blowing agent react to form a foam in a cured state.

Aspect 50. A method of forming the reaction product of any preceding aspect, comprising reacting the reactants according to Reaction Scheme I:

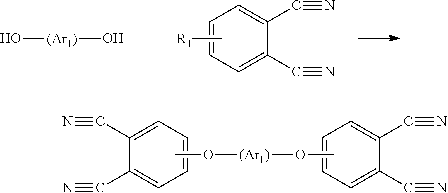

Aspect 51. A method of forming a foam comprising reacting the reaction product of any preceding aspect and the blowing agent according to Reaction Scheme II:

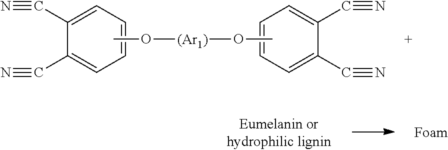

Aspect 52. A substrate comprising a coating formed from the composition of any of aspects 1 to 49 on a portion of a surface of the substrate.

Aspect 53. An article formed from the composition of any of aspects 1 to 49 in a cured state.

Aspect 54. A foam formed from the composition of any of aspects 1 to 49 in a cured state.

Aspect 55. The foam, substrate, or article of any of aspects 52 to 54, wherein the foam is fire resistant.

Aspect 56. The foam, substrate, or article of any of aspects 52 to 55, having a Tg of at least 250° C., such as at least 300° C., such as at least 350° C.

Aspect 57. The foam, substrate, or article of any of aspects 52 to 56, wherein the cured composition has a char yield of at least 60%, such as at least 70%.

Aspect 58. A use of the composition of any of aspects 1 to 49 to form a coating, an article, or a foam that is fire resistant.

Aspect 59. The use of aspect 58 to form a coating, an article, or a foam having a Tg of at 250° C., such as at least 300° C., such as at least 350° C.

Aspect 60. The use of aspect 58 or aspect 59 to form a coating, an article, or a foam having a char yield of at least 60%, such as at least 70%.

### EXAMPLES

### Example 1: Preparation of Foam Using Resveratrol Phthalonitrile and Eumelanin

10.000 parts-by-weight of resveratrol phthalonitrile (maintained in an amorphous state) were ground by hand in a mortar and pestle and transferred to a 70 mm diameter aluminum dish with a lid. 1.000 parts-by-weight of eumelanin [obtained from Naval Air Warfare Center Weapons Division] was then added to the aluminum dish. The mix was heated on a hot plate, at 140° C. until fully melted, then manually mixed with a spatula for at least 2 minutes. The mixture was then removed from the hot plate and cooled until room temperature. The resulting mixture was then cured in an [Yamato DKN602C Constant Temperature Oven] oven [room temperature ~25° C.] by heating at 135° C. (oven set point) for 1 h, 190° C. (oven set point) for 2 h and 270° C. (oven set point) at 8 h with 2° C. per minute ramps. Upon removal and cooling, a solid with extensive porosity and a greatly expanded volume was obtained.

### Example 2: Preparation of Foam Using Magnolia Phthalonitrile and Eumelanin

10.000 parts-by-weight of Magnolia phthalonitrile and 1.000 parts-by weight of eumelanin [obtained from the Navy Research Laboratory] were combined in a mortar and ground by hand with a pestle. The mix was then placed in a 70 mm aluminum dish, with a lid, in the oven. The resulting mixture was then cured at 135° C. (oven set point) for 1 h, 190° C. (oven set point) for 2 h and 270° C. (oven set point) at 8 h with 2° C. per minute ramps. Upon removal and cooling, a solid with extensive porosity and a greatly expanded volume was obtained. Unless noted, procedural details matched those of Example 1.

### Example 3: Preparation of Foam Using Magnolia Phthalonitrile and Hydrophilic Lignin

10.000 parts-by-weight of Magnolia phthalonitrile and 2.000 parts-by weight of KRAFT Lignin [from Millipore Sigma] were combined in a mortar and ground by hand with a pestle. The mix was then placed in a 70 mm aluminum dish, with a lid, in the oven. The resulting mixture was then cured at 135° C. (oven set point) for 1 h, 190° C. (oven set point) for 2 h and 270° C. (oven set point) at 8 h with 2° C. per minute ramps. Upon removal and cooling, a solid with extensive porosity and a greatly expanded volume was obtained. Unless noted, procedural details matched those of Example 1.

### Example 4: Preparation of Foam Using Resveratrol Phthalonitrile and Hydrophilic Lignin

10.000 parts-by-weight of resveratrol phthalonitrile (maintained in an amorphous state), 0.820 parts-by-weight of 3′,5-(5,5′-) diallyl-[1,1′-biphenyl]-2,4′-(2,2′-) diol, and 0.800 parts-by weight of KRAFT Lignin [from Millipore Sigma] were combined in a mortar and ground by hand with a pestle. The mix was then placed in a 70 mm aluminum dish, with a lid, in the oven. The resulting mixture was then cured at 135° C. (oven set point) for 1 h, 190° C. (oven set point) for 2 h and 270° C. (oven set point) at 8 h with 2° C. per minute ramps. Upon removal and cooling, a solid with extensive porosity and a greatly expanded volume was obtained. Unless noted, procedural details matched those of Example 1. The resulting foam had a char yield of 69%, as determined by thermogravimetric analysis (TGA) at 1000° C. under nitrogen at a 10° C./min scan rate.

### Example 5: Testing the Hydrophobicity of Lignin or Melanin

KRAFT Lignin [from Millipore Sigma] and Indulin AT Lignin [from Ingevity] were placed in a clean flat surface between two raised slabs of even thickness. A flat level was then dragged over the top of the two raised surfaces generating a flat and even 1.8 mm thickness layers of the lignins. A drop of DI water was then carefully placed from as close as possible to the top surface. An image was then captured that was on a plane with the drop. The image (shown in FIG. 5) was then used to measure the resulting contact angles on either side of the drop and the contact angles were averaged. The contact angle measurements shown below in Table 1.

TABLE 1
Contact angles and hydrophobicity of different lignins.

| Material | Contact Angle | Hydrophobicity |
|---|---|---|
| Ingevity Indulin AT Lignin | 76° | Hydrophobic |
| Sigma Aldrich Lignin | 0° | Hydrophilic |
| (Millipore Sigma) | | |

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

What is claimed is:

1. A thermoset composition, comprising:
a film-forming component comprising a reaction product of reactants comprising a phenol-containing compound and a phthalonitrile-containing compound; and
a blowing agent comprising eumelanin and/or a hydrophilic lignin.

2. The composition of claim 1, comprising the phenol-containing compound and the phthalonitrile-containing compound in a reactive equivalent ratio of 0.9:1 to 2:1.

3. The composition of claim 1, wherein the phenol-containing compound and/or the blowing agent comprises a bio-enabled compound.

4. The composition of claim 1, wherein the phenol-containing compound comprises resveratrol, magnolol, honokiol, and/or a Magnolia extract.

5. The composition of claim 1, wherein the phthalonitrile-containing compound comprises 3-nitrophthalonitrile, 4-nitrophthalonitrile, or a mixture thereof.

6. The composition of claim 1, wherein the reaction product comprises a number average molecular weight of at least 200 g/mol measured according to gel permeation chromatography and/or mass spectrometry or calculated theoretically.

7. The composition of claim 1, wherein the reaction product comprises an average of one to four phthalonitrile functional groups.

8. The composition of claim 1, wherein the reaction product further comprises a functional group in addition to the phthalonitrile functional group.

9. The composition of claim 8, wherein the additional functional group comprises an alkyl functional group, an alkenyl functional group, an alkynyl functional group, an aryl functional group, a benzyl functional group, a cyanate ester functional group, an epoxy functional group, a benzoxazine functional group, and/or a maleimide functional group.

10. The composition of claim 1, wherein the reaction product comprises a low melt viscosity of less than 100,000 centipoises and/or a high melt viscosity of more than 100,000 centipoises.

11. The composition of claim 1, wherein the blowing agent comprises an ester, a carboxyl, a carboxylate, or a mixture thereof.

12. The composition of claim 1, wherein the blowing agent is an oligomer or a polymer.

13. The composition of claim 1, wherein the blowing agent further comprises a hydroxyl functional group.

14. The composition of claim 1, comprising:
(a) the reaction product in an amount of 30 percent by weight to 99.9 percent by weight based on total weight of the composition; and
(b) the blowing agent in an amount of 0.1 percent by weight to 70 percent by weight based on total weight of the composition.

15. The composition of claim 1, further comprising a curing agent, an additive, a catalyst, a surfactant, a foam stabilizer, and/or a filler.

16. The composition of claim 1, wherein the composition is substantially free of a curing agent, a surfactant, a foam stabilizer, a filler, and/or an azo-derived blowing agent.

17. A substrate comprising a coating formed from the composition of claim 1 on a surface thereof.

18. The substrate of claim 17, wherein the coating is fire resistant, has a Tg of at least 250° C., and/or has a char yield of at least 60%.

19. An article formed from the composition of claim 1 in a cured state.

20. The article of claim 19, wherein the article formed from the composition is fire resistant, has a Tg of at least 250° C., and/or has a char yield of at least 60%.

21. A foam formed from the composition of claim 1 in a cured state.

22. The foam of claim 21, wherein the foam is fire resistant, has a Tg of at least 250° C., and/or has a char yield of at least 60%.
